(19) United States
(12) Patent Application Publication
(10) Pub. No.: US 2018/0278180 A1
(43) Pub. Date: Sep. 27, 2018

(54) POWER CONVERSION SYSTEM

(71) Applicant: TOSHIBA MITSUBISHI-ELECTRIC INDUSTRIAL SYSTEMS CORPORATION, Chuo-ku (JP)

(72) Inventor: Masaru TOYODA, Chuo-ku (JP)

(73) Assignee: TOSHIBA MITSUBISHI-ELECTRIC INDUSTRIAL SYSTEMS CORPORATION, Chuo-ku (JP)

(21) Appl. No.: 15/760,639

(22) PCT Filed: Dec. 4, 2015
(86) PCT No.: PCT/JP2015/084126

§ 371 Date: Mar. 16, 2018

(51) Int. Cl. H02M 7/797; H02J 3/38; H02M 7/521; H02M 1/08; H02J 7/00; H02H 7/122

(52) U.S. Cl. CPC H02M 7/797; H02J 3/383; H02J 3/387; H02M 2001/0009; H02M 1/08; H02J 7/0068; H02H 7/1227; H02M 7/521

(57) ABSTRACT

A power conversion system includes: an output terminal connected to a load; a switch configured to be turned on in a first case that an AC voltage from the AC power supply is normal, and to be turned off in a second case that the AC voltage from the AC power supply is abnormal; a power converter configured to convert the AC power from the AC power supply into DC power and store the DC power in a storage battery in the first case, and to convert the DC power in the storage battery into AC power and output the AC power to the output terminal in the second case; and a line-commutated inverter configured to operate in synchronization with an AC voltage appearing at the output terminal, and convert the DC power supplied from a fuel cell into AC power and output the AC power to the output terminal.

### TECHNICAL FIELD

The present invention relates to power conversion systems, and particularly to a power conversion system that receives alternating current (AC) power supplied from an AC power supply and direct current (DC) power supplied from a DC power supply, and supplies AC power to a load.

### BACKGROUND ART

Japanese Patent Laying-Open No. 2013-150369 (PTD 1) discloses a power conversion system including an AC/DC converter, a first DC/DC converter, a second DC/DC converter, and a DC/AC converter. The AC/DC converter converts an AC voltage supplied from an AC power supply into a first DC voltage and supplies it to a DC linking unit. The first DC/DC converter converts a second DC voltage supplied from a DC power supply into the first DC voltage and supplies it to the DC linking unit. The second DC/DC converter stores DC power in the DC linking unit in a power storage device in a charge mode, and supplies the DC power in the power storage device to the DC linking unit in a discharge mode. The DC/AC converter converts the first DC voltage in the DC linking unit into an AC voltage and supplies it to a load.

### CITATION LIST

### Patent Document

PTD 1: Japanese Patent Laying-Open No. 2013-150369

### SUMMARY OF INVENTION

### Technical Problem

However, the power conversion system of PTD 1, which includes four power converters, suffers from problems of increased device dimensions, increased device cost, and increased power loss.

Accordingly, a main object of the present invention is to provide a small-sized, low-cost and low-loss power conversion system.

### Solution to Problem

A power conversion system according to the present invention is a power conversion system configured to receive alternating current (AC) power supplied from an AC power supply and direct current (DC) power supplied from a DC power supply, and supply AC power to a load, the power conversion system including: an output terminal connected to the load; a switch having a first terminal receiving the AC power supplied from the AC power supply, and a second terminal connected the output terminal, the switch being configured to be turned on in a first case where an AC voltage from the AC power supply is normal, and to be turned off in a second case where the AC voltage from the AC power supply is abnormal; a power converter configured to convert the AC power supplied from the AC power supply through the switch into DC power and store the DC power in a power storage device in the first case, and to convert the DC power in the power storage device into AC power and output the AC power to the output terminal in the second case; and a line-commutated inverter configured to operate in synchronization with an AC voltage appearing at the output terminal, and convert the DC power supplied from the DC power supply into AC power and output the AC power to the output terminal.

### Advantageous Effects of Invention

The power conversion system according to the present invention includes a switch, a power converter, and a line-commutated inverter, thereby realizing a smaller-sized, lower-cost and lower-loss power conversion system than a conventional power conversion system including four self-excited power converters.

### BRIEF DESCRIPTION OF DRAWINGS

FIG. 1 is a circuit block diagram showing the configuration of a power conversion system according to one embodiment of the present invention.

FIG. 2 is a circuit block diagram showing the configuration of an inverter shown in FIG. 1.

FIG. 3 is a block diagram showing the configuration of a control circuit shown in FIG. 2.

FIG. 4 is a diagram showing relation between AC voltages and control signals shown in FIG. 3.

FIG. 5 illustrates diagrams showing waveforms of the control signals shown in FIG. 4.

FIG. 6 is a circuit block diagram showing the configuration of a power converter shown in FIG. 1.

FIG. 7 is a block diagram showing the configuration of a control circuit shown in FIG. 1.

FIG. 8 illustrates time charts showing operation of the power conversion system shown in FIG. 1 upon occurrence of a power failure.

FIG. 9 is a circuit block diagram showing a variation of the embodiment.

FIG. 10 is a circuit block diagram showing another variation of the embodiment.

FIG. 11 is a circuit block diagram showing yet another variation of the embodiment.

FIG. 12 is a circuit block diagram showing yet another variation of the embodiment.

### DESCRIPTION OF EMBODIMENTS

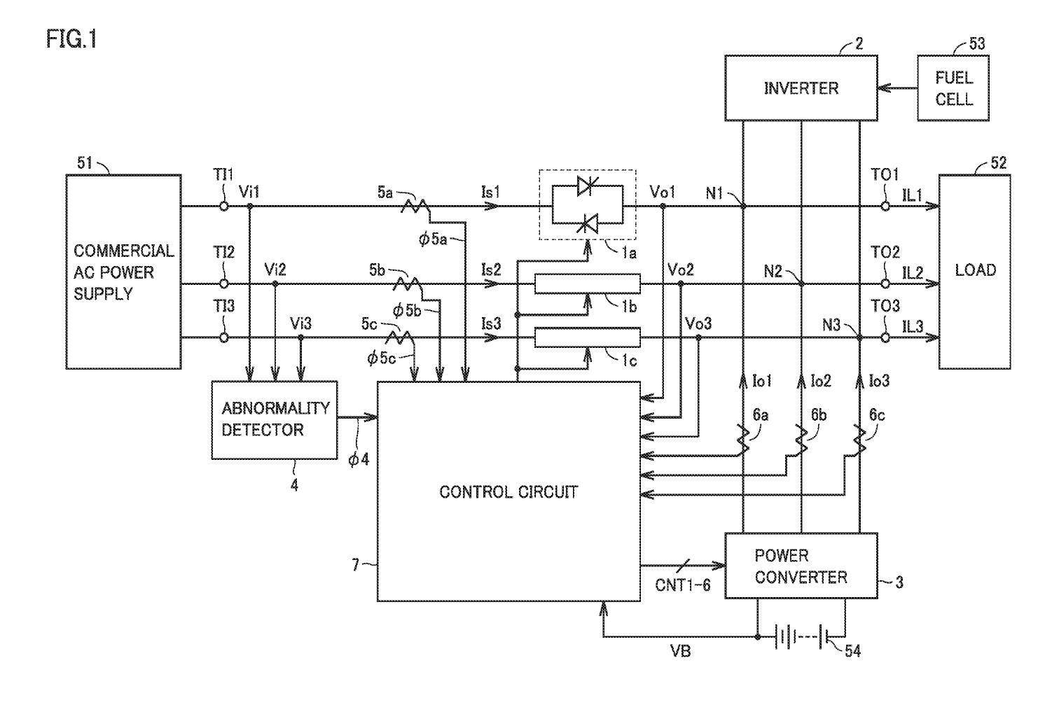

FIG. 1 is a circuit block diagram showing an overall configuration of a power conversion system according to one embodiment of the present invention. In FIG. 1, this power conversion system includes input terminals TI1 to TI3, output terminals TO1 to TO3, switches 1a to 1c, an inverter 2, a power converter 3, an abnormality detector 4, current detectors 5a to 5c and 6a to 6c, and a control circuit 7.

Input terminals TI1 to TI3 receive three-phase AC voltages Vi1 to Vi3, respectively, supplied from a commercial AC power supply 51. Output terminals TO1 to TO3 are connected to a load 52 so as to supply three-phase alternating currents to load 52.

Switches 1a to 1c have first terminals connected to input terminals TI1 to TI3, respectively, and second terminals connected to output terminals TO1 to TO3, respectively. Each of switches 1a to 1c is a switch that does not have self-turn-off capability (self-arc-extinguishing capability), and includes a pair of thyristors, for example. One of the pair of thyristors has an anode and a cathode connected to the first and second terminals, respectively, and the other thyristor has an anode and a cathode connected to the second and first terminals, respectively. Each of switches 1a to 1c may be formed of a mechanical switch.

Switches 1a to 1c are controlled by control circuit 7. Switches 1a to 1c are set to an ON state in the normal situation where three-phase AC voltages Vi1 to Vi3 supplied from commercial AC power supply 51 are normal, and are set to an OFF state when three-phase AC voltages Vi1 to Vi3 supplied from commercial AC power supply 51 become abnormal (for example, when a power failure occurs).

Inverter 2 operates in synchronization with three-phase AC voltages Vo1 to Vo3 appearing at output terminals TO1 to TO3, and converts DC power supplied from a fuel cell 53 (DC power supply) into three-phase AC power and outputs it to AC nodes N1 to N3. AC node N1 is a node between the second terminal of switch 1a and output terminal TO1, AC node N2 is a node between the second terminal of switch 1b and output terminal TO2, and AC node N3 is a node between the second terminal of switch 1c and output terminal TO3. Inverter 2 is of the line-commutated type, and can be operated when three-phase AC voltages Vo1 to Vo3 are appearing at AC nodes N1 to N3.

Fuel cell 53 is a power generation device that generates DC power by the chemical reaction of hydrogen and oxygen. Instead of fuel cell 53, a solar cell that converts solar energy into DC power may be provided.

Power converter 3 is controlled by control circuit 7. In the normal situation where three-phase AC voltages Vi1 to Vi3 supplied from commercial AC power supply 51 are normal, power converter 3 converts three-phase AC power supplied from at least one of AC power supply 51 and inverter 2 into DC power, and stores it in a storage battery 54 (power storage device).

When three-phase AC voltages Vi1 to Vi3 supplied from commercial AC power supply 51 become abnormal, power converter 3 outputs first to third direct currents having the same polarities as those of currents flowing through switches 1a to 1c to AC nodes N1 to N3, to quickly turn off switches 1a to 1c (extinguish arcs in switches 1a to 1c).

That is, when three-phase AC voltages Vi1 to Vi3 supplied from commercial AC power supply 51 become abnormal, an OFF command signal is provided from control circuit 7 to switches 1a to 1c. Since switches 1a to 1c do not have self-turn-off capability, merely providing the OFF command signal cannot turn off switches 1a to 1c, and the currents flowing through switches 1a to 1c need to be set to 0. When the first to third direct currents having the same polarities as those of currents flowing through switches 1a to 1c are output from power converter 3 to AC nodes N1 to N3, load currents IL1 to IL3 are at least partially supplied from power converter 3. Consequently, currents Is1 to Is3 flowing from commercial AC power supply 51 to load 52 through switches 1a to 1c decrease, to quickly turn off switches 1a to 1c.

Furthermore, after switches 1a to 1c are turned off, power converter 3 outputs three-phase alternating currents Io1 to Io3 to load 52 to maintain AC nodes N1 to N3 at rated three-phase AC voltages. Consequently, the operation of inverter 2 is continued, and the operation of load 52 is continued.

Abnormality detector 4 detects whether or not three-phase AC voltages Vi1 to Vi3 supplied from commercial AC power supply 51 are normal. When three-phase AC voltages Vi1 to Vi3 are normal, abnormality detector 4 sets an abnormality detection signal ϕ4 to an “L” level, which is a non-activated level, and when three-phase AC voltages Vi1 to Vi3 become abnormal, abnormality detector 4 sets abnormality detection signal ϕ4 to an “H” level, which is an activated level. For example, during a power failure in which supply of the three-phase AC power from commercial AC power supply 51 is stopped, the effective values of three-phase AC voltages Vi1 to Vi3 decrease, and abnormality detection signal ϕ4 is set to an “H” level, which is an activated level.

Current detectors 5a to 5c are provided between input terminals TI1 to TI3 and switches 1a to 1c, to detect instantaneous values of currents Is1 to Is3 flowing through switches 1a to 1c and output signals ϕ5a to ϕ5c indicating the detected values, respectively. In current detectors 5a to 5c, the polarities of currents flowing from input terminals TI1 to TI3 toward output terminals TO1 to TO3 (that is, the polarities of currents flowing from the first terminals toward the second terminals of switches 1a to 1c) are each assumed as a positive polarity.

Current detectors 6a to 6c are provided between power converter 3 and AC nodes N1 to N3, respectively, to detect instantaneous values of output currents Io1 to Io3 of power converter 3 and output signals ϕ6a to ϕ6c indicating the detected values, respectively. In current detectors 6a to 6c, the polarities of currents flowing from power converter 3 toward AC nodes N1 to N3 are each assumed as a positive polarity.

Control circuit 7 controls switches 1a to 1c and power converter 3 based on output signal ϕ4 of abnormality detector 4, output signals ϕ5a to ϕ5c of current detectors 5a to 5c, output signals ϕ6a to 6c of current detectors 6a to 6c, instantaneous values of voltages Vo1 to Vo3 of output terminals TO1 to TO3, a battery voltage VB (voltage between the terminals of storage battery 54), and so on.

When abnormality detection signal ϕ4 is at an “L” level, which is a non-activated level, control circuit 7 provides an ON command signal to switches 1a to 1c to set them to an ON state. In this case, three-phase AC power is supplied from commercial AC power supply 51 to load 52 through switches 1a to 1c, and DC power generated by fuel cell 53 is converted into three-phase AC power and supplied to load 52, causing the operation of load 52. Furthermore, the three-phase AC power supplied from at least one of commercial AC power supply 51 and inverter 2 is converted into DC power by power converter 3 and stored in storage battery 54.

When abnormality detection signal ϕ4 is set to an “H” level, which is an activated level, control circuit 7 provides an OFF command signal to switches 1a to 1c, and causes power converter 3 to output the first to third direct currents to AC nodes N1 to N3, respectively, to quickly turn off switches 1a to 1c. On this occasion, the polarities of output currents Io1 to Io3 of power converter 3 are the same as the polarities of currents Is1 to Is3 flowing through switches 1a to 1c, respectively.

After switches 1a to 1c are turned off, control circuit 7 causes power converter 3 to supply three-phase AC power to load 52 to continue the operation of load 52. On this occasion, three-phase AC voltages are supplied from power converter 3 to AC nodes N1 to N3, thus allowing line-commutation of inverter 2, whereby three-phase alternating currents are supplied from inverter 2 to load 52. When voltage VB between the terminals of storage battery 54 decreases and reaches a discharge cut-off voltage, the operation of power converter 3 is stopped. Consequently, the line-commutation of inverter 2 is no longer allowed, whereby the operation of inverter 2 is stopped, and the operation of load 52 is stopped.

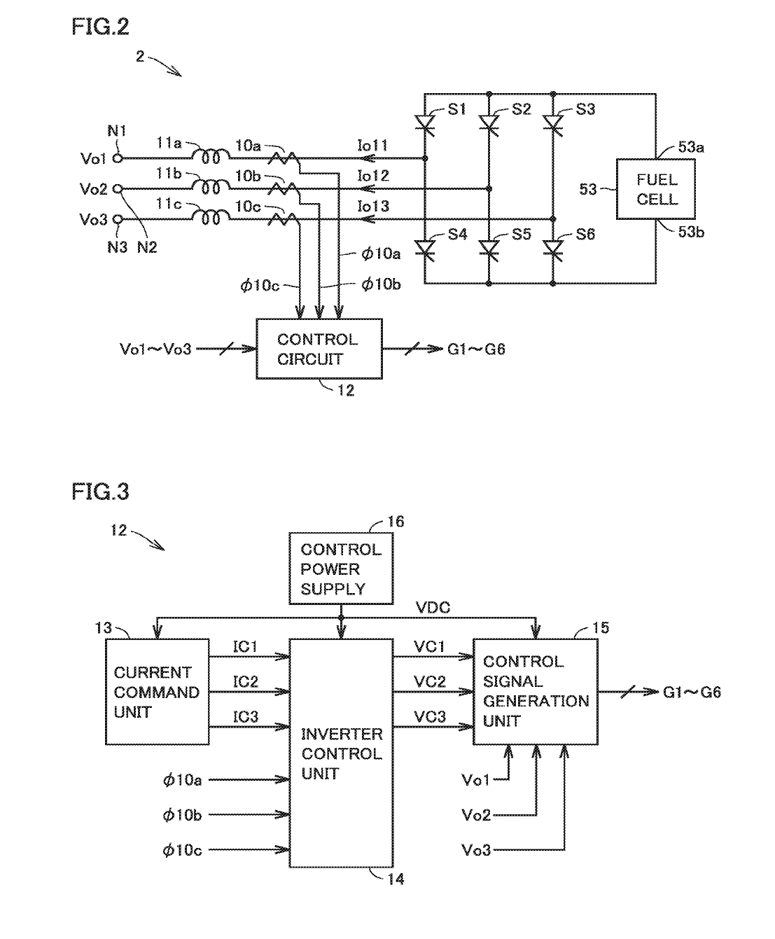

FIG. 2 is a circuit block diagram showing the configuration of inverter 2. In FIG. 2, inverter 2 includes thyristors S1 to S6, current detectors 10a to 10c, reactors 11a to 11c, and a control circuit 12.

Thyristors S1 to S3 have anodes connected to the positive electrode of fuel cell 53, and have cathodes connected to the anodes of thyristors S4 to S6, respectively. Thyristors S4 to S6 have cathodes connected to the negative electrode of fuel cell 53. Thyristors S1 to S6 have gates receiving control signals G1 to G6 from control circuit 12, respectively.

Thyristors S1 to S3 have cathodes connected to one terminals of reactors 11a to 11c, respectively, and reactors 11a to 11c have the other terminals connected to AC nodes N1 to N3, respectively. Current detectors 10a to 10c detect currents Io11 to Io13 flowing through reactors 11a to 11c, that is, output currents Io11 to Io13 of inverter 2, respectively, and output signals ϕ10a to ϕ10c indicating the detected values, respectively.

Control circuit 12 operates in synchronization with three-phase AC voltages Vo1 to Vo3 appearing at AC nodes N1 to N3, and generates control signals G1 to G6 such that the detected values from current detectors 10a to 10c match current command values IC1 to IC3, respectively.

FIG. 3 is a circuit block diagram showing a main part of control circuit 12. In FIG. 3, control circuit 12 includes a current command unit 13, an inverter control unit 14, a control signal generation unit 15, and a control power supply 16. Current command unit 13 outputs current command values IC1 to IC3.

Inverter control unit 14 outputs voltage command values VC1 to VC3 corresponding to deviations IC1-Io11, IC2-Io12, and IC3-Io13 between current command values IC11 to IC13 and detected values Io11 to Io13 from current detectors 10a to 10c, such that detected values Io11 to Io13 from current detectors 10a to 10c match current command values IC1 to IC3, respectively.

Control signal generation unit 15 sets phase control angles α1 to α3 having values corresponding to voltage command values VC1 to VC3, and generates control signals G1 to G6 based on set phase control angles α1 to α3 and the phases of AC voltages Vo1 to Vo3. Control power supply 16 rectifies the voltages of the cathodes of thyristors S1 to S3, and generates a power supply voltage VDC. Control circuit 12 including current command unit 13, inverter control unit 14, and control signal generation unit 15 is driven by power supply voltage VDC from control power supply 16.

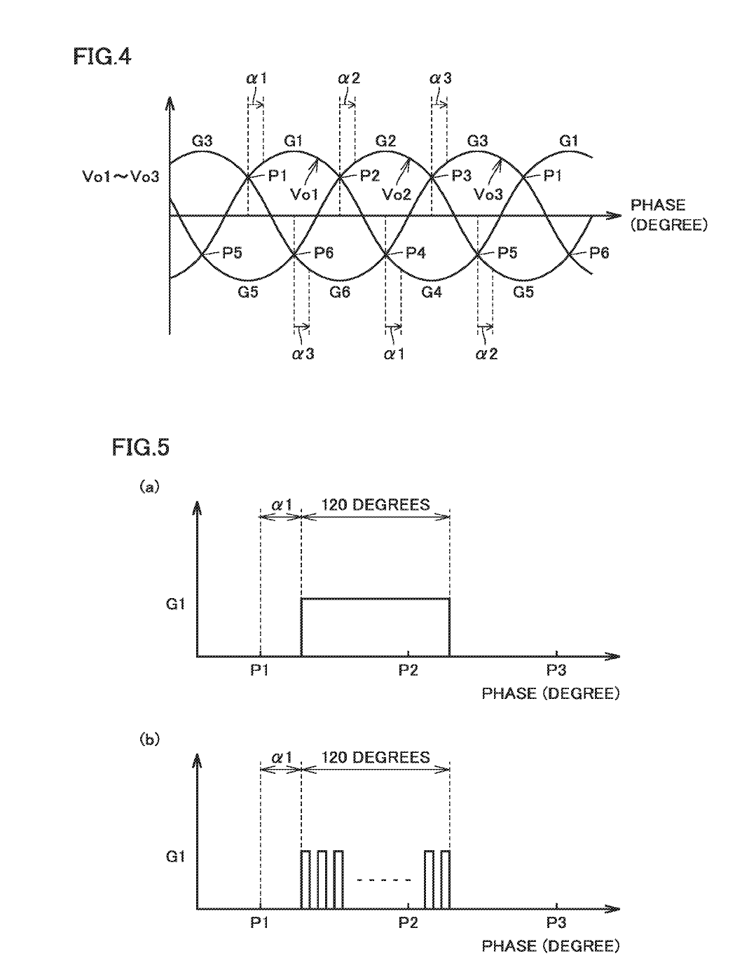

FIG. 4 is a diagram showing relation between AC voltages Vo1 to Vo3 of AC nodes N1 to N3 and control signals G1 to G6. In FIG. 4, each of three-phase AC voltages Vo1 to Vo3 varies in a sinusoidal waveform, and three-phase AC voltages Vo1 to Vo3 are shifted in phase from one another by 120 degrees. The intersection points of AC voltages Vo1, Vo2, Vo3 and AC voltages Vo3, Vo1, Vo2 on the positive voltage side are assumed as P1, P2, P3, respectively, and the intersection points of AC voltages Vo1, Vo2, Vo3 and AC voltages Vo3, Vo1, Vo2 on the negative voltage side are assumed as P4, P5, P6, respectively.

Control signal G1 is raised to an “H” level, which is an activated level, after a delay of phase control angle α1 from intersection point P1, maintained at the “H” level for a period of 120 degrees, and then lowered to an “L” level, which is a non-activated level. Control signal G2 is raised to an “H” level, which is an activated level, after a delay of phase control angle α2 from intersection point P2, maintained at the “H” level for a period of 120 degrees, and then lowered to an “L” level, which is a non-activated level. Control signal G3 is raised to an “H” level, which is an activated level, after a delay of phase control angle α3 from intersection point P3, maintained at the “H” level for a period of 120 degrees, and then lowered to an “L” level, which is a non-activated level.

Control signal G4 is raised to an “H” level, which is an activated level, after a delay of phase control angle α1 from intersection point P4, maintained at the “H” level for a period of 120 degrees, and then lowered to an “L” level, which is a non-activated level. Control signal G5 is raised to an “H” level, which is an activated level, after a delay of phase control angle α2 from intersection point P5, maintained at the “H” level for a period of 120 degrees, and then lowered to an “L” level, which is a non-activated level. Control signal G6 is raised to an “H” level, which is an activated level, after a delay of phase control angle α3 from intersection point P6, maintained at the “H” level for a period of 120 degrees, and then lowered to an “L” level, which is a non-activated level.

FIG. 5 (a) is a diagram showing a waveform of control signal G1. In FIG. 5 (a), control signal G1 is raised to an “H” level after a delay of phase control angle α1 from intersection point P1, maintained at the “H” level for a period of 120 degrees, and then lowered to an “L” level. In other words, control circuit 12 sets the gate of thyristor S1 to an “H” level to turn on thyristor S1 (strike an arc in thyristor S1), and then maintains the gate of thyristor S1 at the “H” level for a period of 120 degrees. Control circuit 12 adjusts phase control angle α1 with which thyristor S1 is turned on, such that the detected value from current detector 10a matches current command value IC11. Assuming that one cycle of AC voltage Vo is T[s], 120 degrees are T/3[s] (predetermined period of time).

FIG. 5 (b) is a diagram showing another waveform of control signal G1. In FIG. 5 (b), control signal G1 is raised to an “H” level for a short period of time after a delay of phase control angle α1 from intersection point P1, then continuously raised to an “H” level at a sufficiently short angle interval (time interval), and then set to an “L” level after a lapse of 120 degrees. In other words, control circuit 12 provides a pulse signal to the gate of thyristor S1 to turn on the thyristor, and then keeps providing the pulse signal to the gate of thyristor S1 at a sufficiently short angle interval for a period of 120 degrees (predetermined period of time). The waveform of each of other control signals G2 to G6 is similar to the waveform of control signal G1.

Generally, one pulse signal is provided to the gate of a thyristor to turn on the thyristor. In this case, there is a risk of the thyristor being turned off when the value of an AC voltage from commercial AC power supply 51 decreases momentarily (that is, during a momentary power interruption). In contrast, in the present embodiment, where the gate of thyristor S is maintained at an “H” level for a period of 120 degrees, or the pulse signal keeps being provided to the gate of thyristor S for a period of 120 degrees, even when thyristor S is turned off during a momentary power interruption, thyristor S can be turned on again when the AC voltage recovers. Accordingly, inverter 2 operates in a stable manner even when a momentary power interruption occurs.

Thyristors S1 to S6 are turned on and off as follows by such control signals G1 to G6. Thyristor S1 is turned on after a delay of phase control angle α1 from intersection point P1, and turned off after a delay of phase control angle α2 from intersection point P2. Thyristor S2 is turned on after a delay of phase control angle α2 from intersection point P2, and turned off after a delay of phase control angle α3 from intersection point P3. Thyristor S3 is turned on after a delay of phase control angle α3 from intersection point P3, and turned off after a delay of phase control angle α1 from intersection point P1.

That is, thyristor S3 is turned off when thyristor S1 is turned on, thyristor S1 is turned off when thyristor S2 is turned on, and thyristor S2 is turned off when thyristor S3 is turned on, to thereby turn on thyristors S1, S2, S3, S1, . . . successively.

Thyristor S4 is turned on after a delay of phase control angle α1 from intersection point P4, and turned off after a delay of phase control angle α2 from intersection point P5. Thyristor S5 is turned on after a delay of phase control angle α2 from intersection point P5, and turned off after a delay of phase control angle α3 from intersection point P6. Thyristor S6 is turned on after a delay of phase control angle α3 from intersection point P6, and turned off after a delay of phase control angle α1 from intersection point P4.

That is, thyristor S6 is turned off when thyristor S4 is turned on, thyristor S4 is turned off when thyristor S5 is turned on, and thyristor S5 is turned off when thyristor S6 is turned on, to thereby turn on thyristors S4, S5, S6, S4, . . . successively. Thyristors S4, S5 and S6 are turned on after a delay of 180 degrees from thyristors S1, S2 and S3, respectively. Thyristor S1 (first thyristor) and thyristor S4 (second thyristor) are alternately turned on, thyristor S2 and thyristor S5 are alternately turned on, and thyristor S3 and thyristor S6 are alternately turned on.

Phase control angle α1 is adjusted such that the detected value from current detector 10a matches current command value IC1. Phase control angle α2 is adjusted such that the detected value from current detector 10b matches current command value IC2. Phase control angle α3 is adjusted such that the detected value from current detector 10c matches current command value IC3.

Such control is only possible when three-phase AC voltages Vo1 to Vo3 are appearing at AC nodes N1 to N3. Accordingly, line-commutated inverter 2 is only operated when three-phase AC voltages Vo1 to Vo3 are appearing at AC nodes N1 to N3, to output three-phase alternating currents.

If a forced-commutated inverter including a forced-turn-off circuit for forcefully turning off thyristors S1 to S6 is provided instead of line-commutated inverter 2, problems of increase in device cost, increase in device dimensions, and increase in power loss arise corresponding to the forced-turn-off circuit.

If a self-excited inverter including a semiconductor element such as an IGBT (Insulated Gate Bipolar Transistor) having self-turn-off capability is provided instead of line-commutated inverter 2, a problem of the occurrence of a great loss (conduction loss, switching loss) in the semiconductor element arises. In contrast, in the present embodiment, where line-commutated inverter 2 is provided, and a conduction loss occurs but a switching loss does not occur in thyristors S1 to S6, the power loss can be reduced as compared with a self-excited inverter.

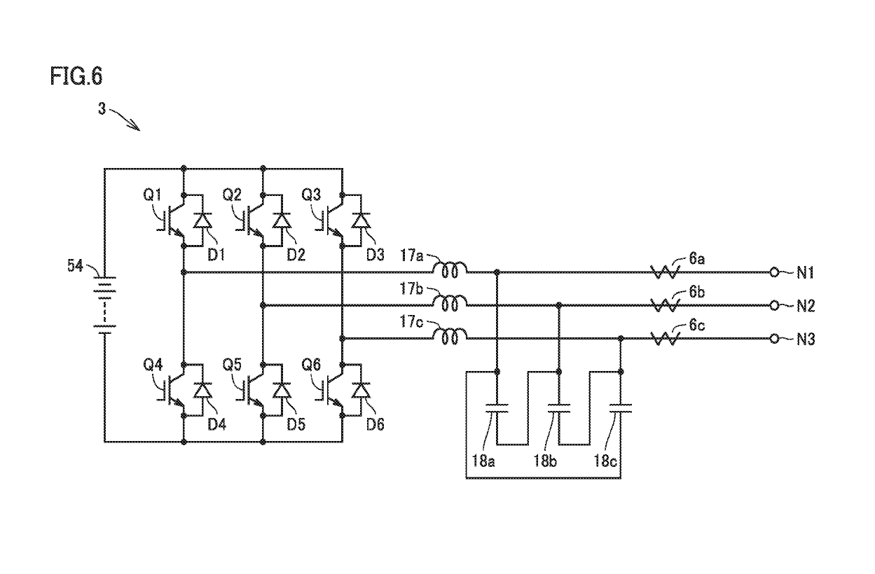

FIG. 6 is a circuit block diagram showing the configuration of power converter 3. In FIG. 6, power converter 3 includes transistors Q1 to Q6, diodes D1 to D6, reactors 17a to 17c, and capacitors 18a to 18c. Each of transistors Q1 to Q6 is an IGBT (Insulated Gate Bipolar Transistor), for example. Transistors Q1 to Q3 have collectors connected to the positive electrode of storage battery 54, and have emitters connected to the collectors of transistors Q4 to Q6, respectively. Transistors Q4 to Q6 have emitters connected to the negative electrode of storage battery 54. Transistors Q1 to Q6 have gates receiving control signals CNT1 to CNT6 from control circuit 7, respectively. Diodes D1 to D6 are connected in anti-parallel with transistors Q1 to Q6, respectively.

Reactors 17a to 17c have one terminals connected to the emitters of transistors Q1 to Q3, respectively, and the other terminals connected to AC nodes N1 to N3, respectively. Capacitors 18a to 18c have one electrodes connected to the other terminals of reactors 17a to 17c, respectively. Capacitors 18a to 18c have the other electrodes connected to the one electrodes of capacitors 18b, 18c and 18a, respectively.

Reactors 17a to 17c and capacitors 18a to 18c form a low pass filter, which allows AC power having a commercial frequency to pass therethrough, and prevents signals having switching frequencies generated in transistors Q1 to Q6 from passing therethrough to load 52. In other words, reactors 17a to 17c and capacitors 18a to 18c convert square wave-shaped three-phase AC voltages generated by transistors Q1 to Q6 into sinusoidal wave-shaped three-phase AC voltages, and output them to AC nodes N1 to N3.

By turning transistors Q1 to Q6 on/off at prescribed timings, three-phase AC voltages of desired phases can be output to AC nodes N1 to N3. When abnormality detection signal ϕ4 is at an “L” level, which is a non-activated level, and when battery voltage VB is lower than a target battery voltage VBT, the phases of the three-phase AC voltages output from power converter 3 to AC nodes N1 to N3 are delayed from the phases of the three-phase AC voltages supplied from commercial AC power supply 51 to AC nodes N1 to N3 through switches 1a to 1c. Consequently, a current flows from commercial AC power supply 51 to storage battery 54 through switches 1a to 1c and power converter 3, to charge storage battery 54.

When battery voltage VB reaches target battery voltage VBT, the phases of the three-phase AC voltages output from power converter 3 to AC nodes N1 to N3 are matched with the phases of the three-phase AC voltages supplied from commercial AC power supply 51 to AC nodes N1 to N3 through switches 1a to 1c. In this case, the charge/discharge of storage battery 54 is stopped, and power converter 3 is set to a standby state.

When abnormality detection signal ϕ4 is set to an “H” level, which is an activated level, the first to third direct currents having the same polarities as those of the currents flowing through switches 1a to 1c are output from power converter 3, to quickly turn off switches 1a to 1c. Then, the DC power in storage battery 54 is converted into three-phase AC power by power converter 3 and supplied to load 52, and AC nodes N1 to N3 are maintained at the prescribed three-phase AC voltages. Consequently, it is now possible to operate inverter 2, whereby the three-phase AC power is supplied from power converter 3 and inverter 2 to load 52, and the operation of load 52 is continued.

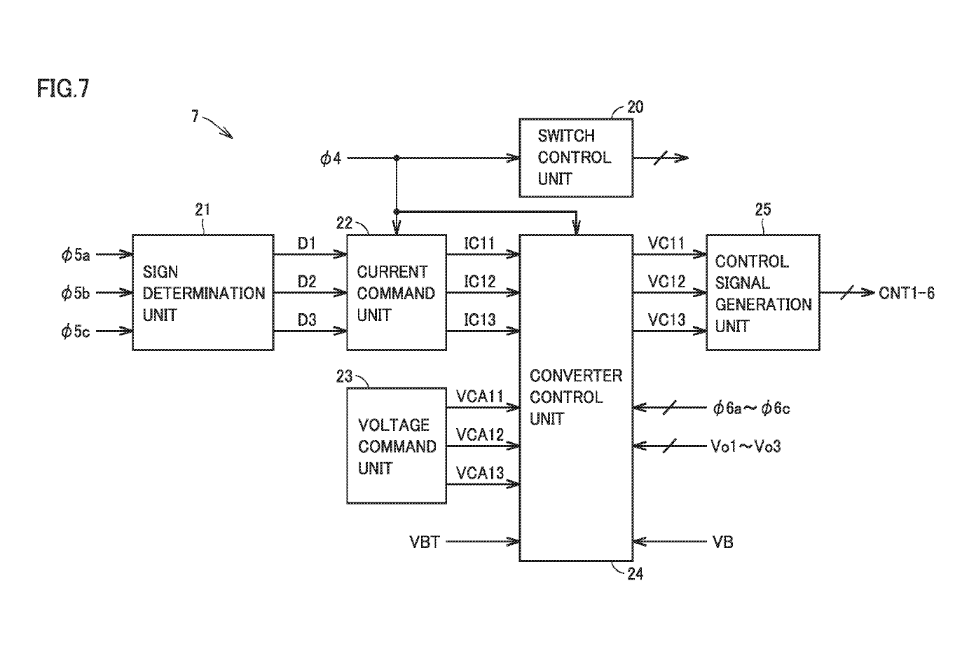

FIG. 7 is a block diagram showing a main part of control circuit 7. In FIG. 7, control circuit 7 includes a switch control unit 20, a sign determination unit 21, a current command unit 22, a voltage command unit 23, a converter control unit 24, and a control signal generation unit 25.

Switch control unit 20 provides an ON command signal to switches 1a to 1c to set switches 1a to 1c to an ON state when abnormality detection signal ϕ4 is at an “L” level, which is a non-activated level, and provides an OFF command signal to switches 1a to 1c to set switches 1a to 1c to an OFF state when abnormality detection signal ϕ4 is set to an “H” level, which is an activated level. As mentioned above, in order to set switches 1a to 1c that do not have self-turn-off capability to an OFF state, it is necessary to provide an OFF command signal to switches 1a to 1c, and to set the currents flowing through switches 1a to 1c to 0.

Sign determination unit 21 determines the polarity of each of currents Is1 to Is3 flowing through switches 1a to 1c based on output signals ϕ5a to ϕ4c of current detectors 5a to 5c, and outputs signals D1 to D3 indicating determination results. When currents Is1 to Is3 have a positive polarity, signals D1 to D3 are set to an “H” level, and when currents Is1 to Is3 have a negative polarity, signals D1 to D3 are set to an “L” level.

When three-phase alternating currents are normally flowing through switches 1a to 1c, two situations happen: a situation where any two of signals D1 to D3 are set to an “H” level and the one remaining signal is set to an “L” level; and a situation where any two of signals D1 to D3 are set to an “H” level and the one remaining signal is set to an “L” level. When currents Is1 to Is3 flowing through switches 1a to 1c become too small to determine a sign, sign determination unit 21 sets all signals D1 to D3 to an “L” level.

Current command unit 22 is activated when abnormality detection signal ϕ4 is set to an “H” level, which is an activated level, and generates current command values IC11 to IC13 such that direct currents Io1 to Io3 having the same polarities as those of currents Is1 to Is3 flowing through switches 1a to 1c are output from power converter 3. Consequently, load currents 1L1 to IL3 are at least partially supplied from power converter 3, and currents Is1 to Is3 flowing through switches 1a to 1c decrease, to quickly turn off switches 1a to 1c.

Voltage command unit 23 outputs three-phase voltage command values VCA11 to VCA13 which vary in a sinusoidal waveform at the same frequencies as those of three-phase AC voltages Vi1 to Vi3 supplied from commercial AC power supply 51. Current command values IC11 to IC13 and voltage command values VCA11 to VCA13 are provided to converter control unit 24.

Converter control unit 24 operates based on abnormality detection signal ϕ4, current command values IC11 to IC13, voltage command values VCA11 to VCA13, output signals ϕ6a to ϕ6c of current detectors 6a to 6c, output voltages Vo1 to Vo3, battery voltage (voltage between the terminals of storage battery 54) VB, and target battery voltage VBT.

When abnormality detection signal ϕ4 is at an “L” level, which is a non-activated level, converter control unit 24 outputs voltage command values VC11 to VC13 at a level corresponding to a deviation VBT-VB between target battery voltage VBT and battery voltage VB. Consequently, output currents Io1 to Io3 of power converter 3 are controlled such that battery voltage VB matches target battery voltage VBT.

Furthermore, when abnormality detection signal ϕ4 is at an “L” level, which is a non-activated level, converter control unit 24 outputs voltage command values VC11 to VC13 at levels corresponding to deviations VCA11-Vo1, VCA12-Vo2, and VCA13-Vo3 between voltage command values VCA11 to VCA13 and output voltages Vo1 to Vo3. Consequently, output currents Io1 to Io3 of power converters 2a to 2c are controlled such that output voltages Vo1 to Vo3 match voltage command values VCA11 to VCA13, respectively, and power converter 3 is set to a standby state.

When abnormality detection signal 44 is set to an “H” level, which is an activated level, converter control unit 24 outputs voltage command values VC11 to VC13 at levels corresponding to deviations IC11-Io1, IC12-Io2, and IC13-Io3 between current command values IC11 to IC13 and detected values Io1 to Io3 from current detectors 6a to 6c. Consequently, output currents Io1 to Io3 of power converter 3 are controlled such that detected values Io1 to Io3 from current detectors 6a to 6c match current command values IC11 to IC13, respectively, and switches 1a to 1c are quickly turned off.

After switches 1a to 1c are turned off, converter control unit 24 outputs voltage command values VC11 to VC13 at levels corresponding to deviations VCA11-Vo1, VCA12-Vo2, and VCA13-Vo3 between voltage command values VCA11 to VCA13 and output voltages Vo1 to Vo3. Consequently, output currents Io1 to Io3 of power converter 3 are controlled such that output voltages Vo1 to Vo3 match voltage command values VCA11 to VCA13, respectively, and the operation of load 52 is continued.

Control signal generation unit 25 generates control signals CNT1 to CNT6 in accordance with voltage command values VC11 to VC13, respectively, and provides generated control signals CNT1 to CNT6 to power converter 3.

Next, the operation of this power conversion system will be described. When three-phase AC voltages Vi1 to Vi3 supplied from commercial AC power supply 51 are normal, abnormality detection signal 44 is set to an “L” level, which is a non-activated level, by abnormality detector 4. When abnormality detection signal ϕ4 is at an “L” level, an ON command signal is provided from switch control unit 20 to switches 1a to 1c to set switches 1a to 1c to an ON state, and three-phase alternating currents are supplied from commercial AC power supply 51 to load 52 through switches 1a to 1c.

On this occasion, DC power generated by fuel cell 53 is converted into three-phase AC power by inverter 2, and three-phase alternating currents are supplied from inverter 2 to load 52. Load 52 is driven by the three-phase alternating currents supplied from commercial AC power supply 51 and inverter 2. Furthermore, power converter 3 converts three-phase AC power supplied from commercial AC power supply 51 into DC power, and stores it in storage battery 54. When battery voltage (voltage between the terminals of storage battery 54) VB reaches target battery voltage VBT, power converter 3 is set to a standby state.

When three-phase AC voltages Vi1 to Vi3 supplied from commercial AC power supply 51 become abnormal, abnormality detection signal ϕ4 is set to an “H” level, which is an activated level, by abnormality detector 4. When abnormality detection signal ϕ4 is set to an “H” level, an OFF command signal is provided from switch control unit 20 to switches 1a to 1c, the DC power in storage battery 54 is converted into DC power by power converter 3, and direct currents Io1 to Io3 are output from power converter 3.

On this occasion, the polarities of direct currents Io1 to Io3 are set to be the same as the polarities of currents Is1 to Is3 flowing through switches 1a to 1c, respectively. Load currents IL1 to IL3 are at least partially replaced by direct currents Io1 to Io3 and currents Is1 to Is3 flowing through switches 1a to 1c decrease, to quickly turn off switches 1a to 1c and set them to an OFF state.

When switches 1a to 1c are set to an OFF state, three-phase alternating currents are supplied from power converter 3 to load 52, and AC nodes N1 to N3 are maintained at prescribed three-phase AC voltages Vo1 to Vo3. Consequently, the operation of inverter 2 is continued, and three-phase alternating currents are supplied from inverter 2 to load 52. Load 52 is driven by the three-phase alternating currents from power converter 3 and inverter 2.

Accordingly, the operation of load 52 is continued during a period in which the DC power is stored in storage battery 54. When battery voltage VB decreases and reaches a discharge cut-off voltage, the operation of power converter 3 and inverter 2 is stopped, and the operation of load 52 is stopped.

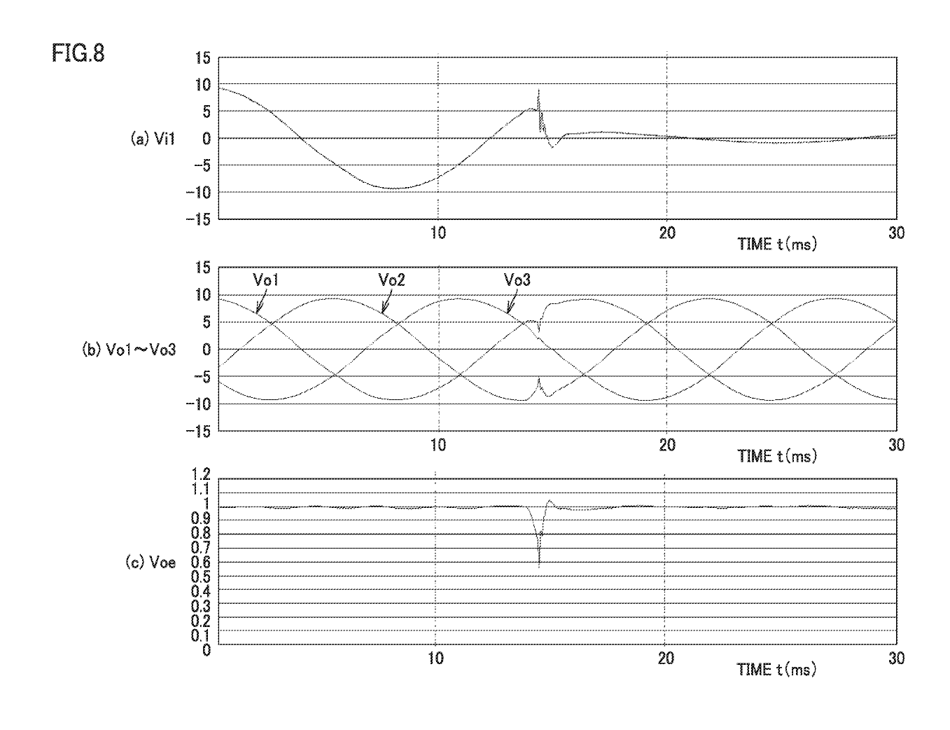

FIGS. 8 (a) to (c) are time charts showing the operation of the power conversion system upon occurrence of a power failure. In particular, FIG. 8 (a) shows a waveform of AC voltage Vi1 supplied from commercial AC power supply 51, FIG. 8 (b) shows waveforms of three-phase AC voltages Vo1 to Vo3 supplied to load 52, and FIG. 8 (c) shows an effective value Voe of three-phase AC voltages Vo1 to Vo3 supplied to load 52.

FIGS. 8 (a) to (c) show a case where a power failure occurs at a certain time (14 ms in the figures). When a power failure occurs, as shown in FIG. 8 (a), the amplitude of AC voltage Vi1 from commercial AC power supply 51 decreases to about one-tenth or less of the amplitude in the normal situation. As mentioned above, when a power failure occurs in the power conversion system of the present embodiment, switches 1a to 1c are turned off to electrically disconnect commercial AC power supply 51 and load 52 from each other, and three-phase AC power is supplied from power converter 3 and inverter 2 to load 52. For this reason, as shown in FIGS. 8 (b) and (c), although the amplitude and effective value Voe of AC voltage Vo supplied to load 52 decrease momentarily to about 55% of those in the normal situation, AC voltage Vo recovers to a sinusoidal wave shape without waveform distortion in several ms which is equal to or less than half a cycle of AC voltage Vo.

As described above, in the present embodiment, where switches 1a to 1c, line-commutated inverter 2 and power converter 3 are provided, a smaller-sized, lower-cost and lower-loss power conversion system can be realized than a conventional power conversion system including four self-excited power converters.

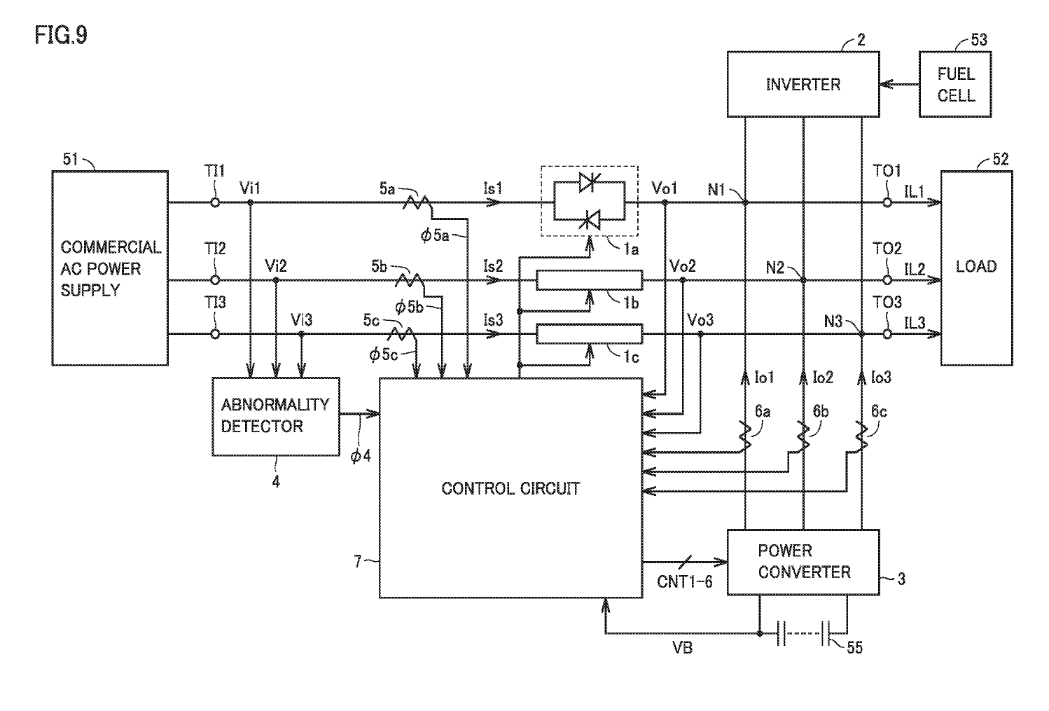

FIG. 9 is a circuit block diagram showing a variation of the present embodiment, and illustrated as compared with FIG. 1. Referring to FIG. 9, this variation is different from the embodiment in that an electrical double layer capacitor 55 is provided instead of storage battery 54. This variation can further reduce the size, cost and loss of the device than in the embodiment.

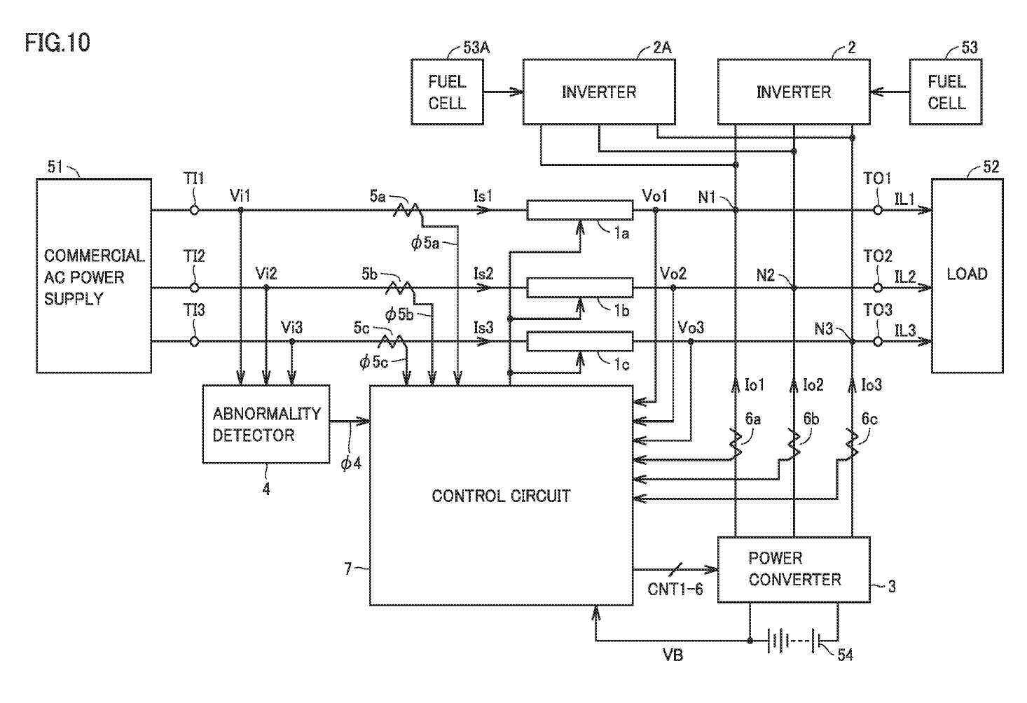

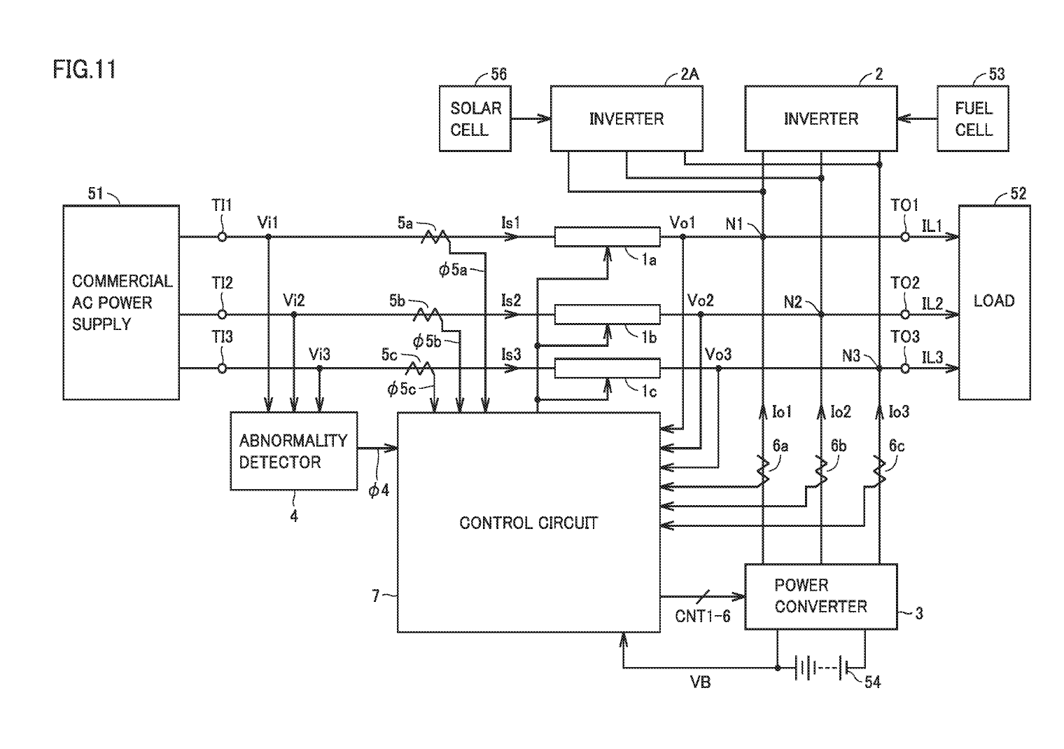

FIG. 10 is a circuit block diagram showing another variation of the present embodiment, and illustrated as compared with FIG. 1. Referring to FIG. 10, this variation is different from the embodiment in that an inverter 2A and a fuel cell 53A are added. Inverter 2A and fuel cell 53A are the same as inverter 2 and fuel cell 53, respectively. Line-commutated inverter 2A converts DC power generated in fuel cell 53A into three-phase AC power, and outputs it to AC nodes N1 to N3.

In this variation, in addition to producing the same effects as those in the embodiment, even when a failure occurs in one of the fuel cells, the operation can be continued by the other fuel cell. Furthermore, the plurality of sets of inverters and fuel cells can be arranged in a distributed manner at a plurality of locations, thereby increasing the flexibility of the device layout. While two sets of inverters and fuel cells are provided in this variation, three or more sets of inverters and fuel cells may be provided. One set of inverter 2 and fuel cell 53 may be divided into a plurality of sets of sub-inverters and sub-fuel cells and arranged in a distributed manner.

FIG. 11 is a circuit block diagram showing yet another variation of the present embodiment, and illustrated as compared with FIG. 10. Referring to FIG. 11, this variation is different from the variation of FIG. 10 in that fuel cell 53A is replaced by a solar cell 56. The output of fuel cell 53 is reduced when solar cell 56 generates a great output (during the day, for example), and the output of fuel cell 53 is increased when solar cell 56 generates a small output (at night, for example). In this variation, in addition to producing the same effects as those in the embodiment, the amount of fuel consumption by fuel cell 53 can be suppressed at low level. While two types of DC power supplies (fuel cell 53 and solar cell 56) and two inverters 2, 2A are provided in this variation, three or more types of DC power supplies and three or more inverters may be provided. One set of inverter 2 and fuel cell 53 may be divided into a plurality of sets of sub-inverters and sub-fuel cells and arranged in a distributed manner, and one set of inverter 2A and fuel cell 56 may be divided into a plurality of sets of sub-inverters and sub-solar cells and arranged in a distributed manner.

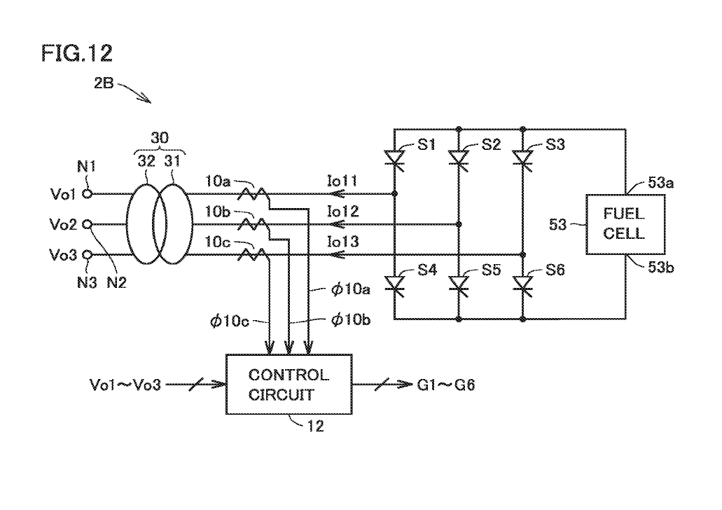

FIG. 12 is a circuit block diagram showing yet another variation of the present embodiment, and illustrated as compared with FIG. 2. Referring to FIG. 12, this variation is different from the embodiment in that inverter 2 is replaced by an inverter 2B. In inverter 2B, reactors 11a to 11c of inverter 2 are replaced by a three-phase transformer 30. Thyristors S1 to S3 have cathodes connected to three terminals of a primary winding 31 of three-phase transformer 30, respectively. A secondary winding 32 of three-phase transformer 30 has three terminals connected to AC nodes N1 to N3, respectively.

Primary winding 31 and secondary winding 32 are electromagnetically coupled to each other, but are insulated from each other. The number of turns of secondary winding 32 is higher than the number of turns of primary winding 31. Three-phase transformer 30 boosts the three-phase AC voltages generated by thyristors S1 to S6, and supplies them to AC nodes N1 to N3. In this variation, in addition to producing the same effects as those in the embodiment, even when an output voltage of fuel cell 53 is low, three-phase AC power can be supplied to load 52 in coordination with commercial AC power supply 51.

It should be understood that the embodiments disclosed herein are illustrative and non-restrictive in every respect. The scope of the present invention is defined by the terms of the claims, rather than the description above, and is intended to include any modifications within the meaning and scope equivalent to the terms of the claims.

### REFERENCE SIGNS LIST

TI1 to TI3 input terminal; TO1 to TO3 output terminal; 1a to 1c switch; 2, 2A, 2B inverter; 3 power converter; 4 abnormality detector; 5a to 5c, 6a to 6c, 10a to 10c current detector; 7, 12 control circuit; S1 to S6 thyristor; 11a to 11c, 17a to 17c reactor; N1 to N3 AC node; 13, 22 current command unit; 14 inverter control unit; 15 control signal generation unit; 16 control power supply; Q1 to Q6 transistor; D1 to D6 diode; 18a to 18c capacitor; 20 switch control unit; 21 sign determination unit; 23 voltage command unit; 24 converter control unit; 25 control signal generation unit; 30 three-phase transformer; 51 commercial AC power supply; 52 load; 53, 53A fuel cell; 54 storage battery; 55 electrical double layer capacitor; 56 solar cell.

1. A power conversion system configured to receive alternating current (AC) power supplied from an AC power supply and direct current (DC) power supplied from a DC power supply, and supply AC power to a load, the power conversion system comprising:
an output terminal connected to the load;
a switch having a first terminal receiving the AC power supplied from the AC power supply, and a second terminal connected the output terminal, the switch being configured to be turned on in a first case where an AC voltage from the AC power supply is normal, and to be turned off in a second case where the AC voltage from the AC power supply is abnormal;
a power converter configured to convert the AC power supplied from the AC power supply through the switch into DC power and store the DC power in a power storage device in the first case, and to convert the DC power in the power storage device into AC power and output the AC power to the output terminal in the second case; and
a line-commutated inverter configured to operate in synchronization with an AC voltage appearing at the output terminal, and convert the DC power supplied from the DC power supply into AC power and output the AC power to the output terminal.

2. The power conversion system according to claim 1, wherein
the inverter includes
a first thyristor having an anode connected to a positive electrode of the DC power supply, and a cathode connected to the output terminal,
a second thyristor having an anode connected to the cathode of the first thyristor, and a cathode connected to a negative electrode of the DC power supply, and
a control circuit configured to turn on the first and second thyristors alternately in synchronization with the AC voltage appearing at the output terminal.

3. The power conversion system according to claim 2, wherein
the control circuit is configured to
set a gate of the first thyristor to an activated level to turn on the first thyristor, and then maintain the gate of the first thyristor at the activated level for a predetermined period of time, and
set a gate of the second thyristor to an activated level to turn on the second thyristor, and then maintain the gate of the second thyristor at the activated level for a predetermined period of time.

4. The power conversion system according to claim 2, wherein
the control circuit is configured to
provide a pulse signal to a gate of the first thyristor to turn on the first thyristor, and then keep providing a plurality of pulse signals to the gate of the first thyristor for a predetermined period of time, and
provide a pulse signal to a gate of the second thyristor to turn on the second thyristor, and then keep providing a plurality of pulse signals to the gate of the second thyristor for a predetermined period of time.

5. The power conversion system according to claim 2, wherein
the inverter further includes a reactor connected between the cathode of the first thyristor and the output terminal.

6. The power conversion system according to claim 2, wherein
the inverter further includes a transformer connected between the cathode of the first thyristor and the output terminal.

7. The power conversion system according to claim 1, further comprising:
an abnormality detector configured to detect that the AC voltage from the AC power supply has become abnormal;
a current detector configured to detect an instantaneous value of a current flowing through the switch; and
a control circuit configured to control the switch and the power converter based on detection results from the abnormality detector and the current detector, wherein
the switch does not have self-turn-off capability,
in the first case, the switch is set to an ON state, and an alternating current is supplied from the AC power supply to the load through the switch,
in the second case, an OFF command signal is provided from the control circuit to the switch and a direct current is output from the power converter to turn off the switch, and furthermore, an alternating current is supplied from the power converter to the load, and
assuming that a polarity of a current flowing from the first terminal toward the second terminal of the switch is a positive polarity, and a polarity of a current flowing from the power converter toward the output terminal is a positive polarity, a polarity of the direct current is the same as the polarity of the current flowing through the switch.

8. The power conversion system according to claim 1, wherein
the DC power supply is a fuel cell.

9. The power conversion system according to claim 1, wherein
the DC power supply is a solar cell.

10. The power conversion system according to claim 1, wherein
the DC power supply includes a plurality of sub-DC power supplies,
the inverter includes a plurality of sub-inverters, each one of the plurality of sub-inverters being provided for a corresponding one of the plurality of sub-DC power supplies, and
each of the sub-inverters is connected to the output terminal, and is configured to convert DC power generated in a corresponding one of the sub-DC power supplies into AC power and output the AC power to the output terminal.

11. The power conversion system according to claim 10, wherein
the plurality of sub-DC power supplies include a fuel cell and a solar cell.

12. The power conversion system according to claim 1, wherein
the power storage device is a storage battery.

13. The power conversion system according to claim 1, wherein
the power storage device is an electrical double layer capacitor.
